(19) United States
(12) Patent Application Publication
(10) Pub. No.: US 2023/0354835 A1
(43) Pub. Date: Nov. 9, 2023

(54) USE OF LIQUID SMOKE IN CONJUNCTION WITH FOOD GRADE COATINGS TO CONTROL PEST INFESTATIONS

(71) Applicant: Mississippi State University, Starkville, MS (US)

(72) Inventors: Mark Schilling, Starkville, MS (US); Wenjie Shao, Starkville, MS (US); Yan Campbell, Starkville, MS (US); Thomas Phillips, Manhattan, KS (US)

(21) Appl. No.: 18/314,061

(22) Filed: May 8, 2023

Related U.S. Application Data
(60) Provisional application No. 63/339,037, filed on May 6, 2022.

(51) Int. Cl. A23B 4/20; A01N 65/00; A01P 7/02; A23B 4/048; A23L 3/3544; A23L 3/349; A23L 13/00; B65D 81/28

(52) U.S. Cl. CPC A23B 4/20; A01N 65/00; A01P 7/02; A23B 4/048; A23L 3/3544; A23L 3/349; A23L 13/03; B65D 81/28

(57) ABSTRACT

A food-grade coating composition for controlling pest infestation and pest reproduction on or in food, or both, wherein the composition comprises mixtures containing liquid smoke and at least one of xanthan gum, propylene glycol, alginate, and/or carrageenan, and the composition can be infused into a container to be placed on or around the food.

### PRIOR APPLICATIONS

This application claims benefit of U.S. Patent Application 63/339,037, filed May 6, 2022, the contents of which are incorporated herein by reference.

### GOVERNMENT INTEREST

This invention was made with government support under Grant Number 2015-51102-24143 awarded by the U.S. Department of Agriculture, National Institute of Food and Agriculture. The government has certain rights in the invention.

### TECHNICAL FIELD

The presently-disclosed subject matter relates to compositions for food grade coatings. In particular, the presently-disclosed subject matter relates to food grade coatings made with xanthan gum, propylene glycol, propylene glycol alginate, and/or carrageenan in conjunction with liquid smoke for use to control pests on aged food products. The invention also discloses composition-treated containers and methods for infusing coatings, including those of the invention, into food containers, wraps, and nets used to store and/or cure the foods.

The invention provides pest protection efficacy and enhanced shelf life characteristics for food (ham) stored within food containers (nets) treated with various combinations of composition mixtures of the invention and subsequently protected for up to at least about eight (8) weeks.

### BACKGROUND AND SUMMARY OF THE INVENTION

The present inventors have discovered that the use of liquid smoke with xanthan gum controlled mite growth. Also, the present inventors have discovered that infusing compositions of the present invention into nets controlled mite growth. Further, the compositions of the present invention did not impact the sensory qualities of country ham as edible coatings. Thus, liquid smoke can be added in coatings or ham nets to control mites and used in an integrated pest management program for dry-cured hams.

Country ham production is concentrated and rooted in the Southeastern region of the United States, including North Carolina, Tennessee, Missouri, Kentucky, Virginia, and Georgia (Hanson et al., 2014). The traditional processing stages of country ham include raw material selection, curing, equalization (or drying), smoking (optional), and aging (Hanson et al., 2014; Rentfrow et al., 2012). The curing procedure starts with the hand application of the dry-cure ingredients, including salt (approximately 80%), sugar (approximately 20%), nitrate (99.2 g to 45.36 kg of ham) and proprietary spice blends (Rentfrow et al., 2012; USDA-FSIS 9 CFR 424.21, 2021). One common curing method is to apply half of the dry-curing mixture on the lean surface of the whole ham (especially on the lean surface) and refrigerate for 5-7 days. The rest of the dry-curing mixture is applied and the hams are refrigerated for an additional 35 days at 2.5-3.0° C. (Hanson et al., 2014). After the initial curing procedure, the excess salt is rinsed off with water that is 10° C. or colder. In the equalization step, the hams are stored at 10-12.5° C. with 55%-70% relative humidity (RH) for 13 to 30 days (Hanson et al., 2014). The last step is aging, normally with temperatures ranging from 21 to 30° C. and 55-65% RH (Hanson et al., 2014; Marriott and Schilling, 2004), and in some processing facilities the RH could be greater. Most country ham processors age hams 3 to 6 months, but some ham producers age hams for 6 to 24 months to produce a premier product with desirable flavors (Rentfrow et al., 2012).

Tyrophagus putrescentiae (Schrank, 1781; Mold mite), the ham mite, also called the cheese mite, is a pest that infests stored food products with a high protein and fat ratio (Gulati and Mathur, 1995), including dry-cured hams (Armentia et al., 1994; Sanchez-Ramos and Castañera, 2000). Mold mites mate soon and repeatedly after eclosion (Boczek, 1991). A female mold mite can lay 4 eggs per day, and 70% of the eggs that are produced by a female mite during her life span are laid during the first 3 weeks of life. If the temperature is favorable and relative humidity is 90% to 100%, one female mite can lay an average of 437 eggs during its lifetime (lifetime is 115 days at 9.3° C. and is 42.8 days at 31° C.) (Rodriguez et al., 1987). Mold mites develop from the egg stage to the adult stage under the environmental conditions of 8.5-36° C., and ≥60% RH with optimum development at 30-36° C. and 78% RH (Boczek, 1991; Žd'árková, 1973; Cunnington, 1969; Mueller et al., 2006). For mold mites to completely develop, the RH needs to be 60% or greater, with an optimal RH of 78% (Boczek, 1991; Žd'árková, 1973). The development of the mold mite only happens at between 8.5° C. to 36° C. (Cunnington, 1969). The optimal temperature for mold mite growth is between 30 and 36° C. (Mueller et al., 2006). The temperature in an aging room range is commonly between 21 and 30° C. (Hanson et al., 2014; Marriott and Schilling, 2004) and cannot exceed 35° C. (USDA FSIS 9 CFR 319.106, 2021). The RH in aging rooms is typically around 55% to 65% and some times higher (Hanson et al., 2014; Marriott and Schilling, 2004; Rentfrow et al., 2012). This makes dry-cured ham aging room a viable environment for mites to reproduce and grow.

The United States Department of Agriculture (USDA) considers dry-cured hams adulterated if mites are present at any time during production or commerce (USDA-FSIS 9 CFR 301, 9 CFR 416). Ham mites can also cause allergic reactions in humans. Green et al. (1978) reported that positive reactions to T. putrescentiae were as frequent as those for Dermatophagoides pteronyssinus in asthmatics in the Sydney population. It was concluded that both T. putrescentiae and D. pteronyssinus are sources of allergens. Del Rio et al. (2012) reported a case in which a patient was working as a dry-cured ham delivery man in Madrid, Spain. He experienced occupational asthma which was caused by T. putrescentiae. Another case reported by Armentia et al. (1994) indicated that T. putrescentiae was an allergen on dry-cured ham that caused an occupational allergy.

Methyl bromide (MB) has been used throughout the world as a fumigant of stored food (Bond, 1984; Fields, 1992; Fields and White, 2002), but was listed as an ozone-depleting substance in 1992 in the Montreal Protocol (Osteen, 2003) and its use is prohibited in many countries, with the exception of quarantine treatments. As documented in 40 CFR 82, dry-cured pork was one of the only two agricultural products that were permitted to use MB in 2016 Critical Use Exemption (EPA, 2015). Currently, MB stockpiles can be used to fumigate dry-cured pork, but no additional methyl bromide can be manufactured. Therefore, before the pre-phaseout MB inventories are depleted, it is important to develop safe, environmentally friendly, and affordable technologies to control mite growth and infestations.

It is therefore important to find viable ingredients that are environmentally friendly. The present invention helps meet those needs.

In Spain, hams are often coated with lard and/or vegetable oil to control mites (Garcia, 2004). Abbar et al. (2016a) used food-grade compounds, including salts, organic acids, fats and oils, organic alcohols, polysaccharides, and other food additives as coating substances to evaluate their effectiveness at controlling mite growth on dry-cured ham cubes (2.5×2.5×2.5 cm³). Results indicated that 100% propylene glycol (PG, 1,2-propanediol), 50% PG in water, 100% lard in hexane, 10% ethoxyquin in acetone, and 10% butylated hydroxytoluene in ethanol were effective at inhibiting mite growth on dry-cured ham cubes (Abbar et al., 2016a). Zhao et al. (2014) conducted experiments on water vapor permeability by coating whole hams with different coating solutions (hot lard dip, 100% PG, and 2% carrageenan (CG)+50% PG). After 48 days, whole hams that were coated with a thin layer of lard lost 5.3% of their original weight compared to 7.4% of control hams. Hams treated with 2% CG+50% PG lost 6.4% of weight. Hams coated with a thin layer of diatomaceous earth lost 6.8% of their original weight. Therefore the lard may act as a layer to delay dehydration and extend aging time (Zhao et al., 2016a). Zhao et al. (2016) conducted experiments, and results indicated that ham cubes (2.5×2.5×2.5 cm³) coated with xanthan gum (XG)+20% PG and CG+propylene glycol alginate (PGA)+10% PG solution controlled mite population growth. Campbell et al. (2018) used nets made of cotton and nets made of polyester/cotton blend, and the nets were infused with PGA+CG+PG. The results indicated that nets can be used as a carrier of coating solution and 10% PG was the minimum amount required to effectively control mite growth.

Traditional smoking of foods, especially meats, has been used as a preservation technique for centuries. Wood smoke, in addition to preserving food quality with its antioxidant and antimicrobial properties, also imparts a desirable color, flavor and aroma to smoked foods.

Application of liquid smoke requires less time than traditional smoking, is more environmentally friendly, and eliminates potentially toxic compounds while still imparting the desired flavors and aromas of traditional smoking. Use of condensates of liquid smoke allows the processor to control the concentration of smoke being applied more readily than generating smoke by burning of wood. Liquid smoke is traditionally applied to meat, fish and poultry and it has also been used to impart flavor to non-meat items such as cheese, tofu and even pet food. Because the smoke flavor is concentrated, application of liquid smoke is best suited for use in marinades, sauces or brines or topically to processed meat items such as hot dogs, sausage, ham and bacon.

The invention of liquid smoke is credited to E. H. Wright, a late 19^{th} century Kansas pharmacist. The product was initially used in a domestic setting for the curing of bacon and hams, as well as for the flavoring of products such as stews and baked beans. Smoke flavors have been produced on a large scale since the 1970's and are now progressively replacing traditional smoking methods. Liquid smoke methods have gained popularity over traditional methods due to several advantages like ease and speed of application, uniformity of product, final product reproducibility, functionality and reactionary properties, and cleanliness of application. Since its introduction into the food industry, liquid smoke has taken on several functionalities independent of smoking meats.

Liquid smoke is typically produced by condensing wood smoke created by the controlled, minimal oxygen pyrolysis of sawdust or wood chips. The wood is placed in large retorts where intense heat is applied, causing the wood to smolder, releasing the gases seen in ordinary smoke. These gases are quickly chilled in condensers, which liquefies the smoke. The liquid smoke is then forced through refining vats, and then filtered to remove toxic and carcinogenic impurities. Finally, the liquid may be aged for mellowness. Factors influencing the flavor of liquid smoke include the temperature of smoke generation, moisture content of the wood as well as the type of wood used to generate the smoke. Common woods include hickory and mesquite, but liquid smoke has also been prepared from rice hulls, coconut shells and pecan shells.

In general, woods used to generate liquid smoke are roughly comprised of 25% hemicellulose, 50% cellulose, and 25% lignins. Pyrolysis occurs in four stages starting with water evaporation, followed by decomposition of hemicelluloses, cellulose decomposition and finally decomposition of lignins. Pyrolysis of hemicellulose and cellulose occurs between 180° C. and 350° C. and produces carboxylic acids and carbonyl compounds while lignins are pyrolyzed between 300° C. and 500° C. and generate phenols. Compounds present in liquid smoke, including phenols, are responsible for the smoke flavor and smoky aroma while carbonyl compounds impart a sweet aroma and color to smoked meat products. In addition to carbonyls, acids, and phenols, pyrolysis of wood often generates unfavorable compounds such as polycyclic aromatic hydrocarbons. Although they are toxic, they have low water solubility which allows liquid smoke manufacturers to easily separate out these compounds from their finished products using phase separation and filtration techniques.

The major proportion of commercial full-strength liquid smoke is usually water (11-92%), tar (1-17%), acids (2.8-9.5%), carbonyl containing compounds (2.6-4.6%) and phenol derivatives (0.2-2.9%). Phenolic compounds contribute to smoke flavor and color of liquid smokes, and also have antibacterial and antioxidant properties. Carbonyl-containing compounds impart sweet or burnt-sweet aroma and tend to soften the heavy smoky aroma associated with phenolic compounds with some ‘typical smoke-cured’ aroma and flavors. Furthermore, carbonyl-containing compounds are involved in textural changes in smoked food caused by interaction with proteins and contribute to the golden-brown color of smoked products due to reaction with amino acids, and the formation of Maillard reaction products.

The composition of wood smoke is directly related to the type of wood source. Generally, trees are composed of approximately 45% cellulose, 20-30% lignin (polyphenol), and 25-35% hemicellulose. All wood sources yield smoke that is a very complex mixture of over 400 different compounds including alcohols, carbonyls, esters, furans, lactones, phenols, and others. Identification of compounds present in wood smoke is possible through the use of gas chromatography-mass spectrometry (GC-MS) methods. Some of the over 400 volatiles identified in liquid smoke are summarized in the table below. This list includes only a few of the 48 acids, 22 alcohols, 131 carbonyls, 22 esters, 46 furans, 16 lactones, 75 phenols, and 50 miscellaneous compounds known to exist in liquid smoke.

TABLE
Compounds primarily identified in wood smoke.

| Group | Compounds |
|---|---|
| Alcohols | Methyl, Ethyl, Propyl, Isopropyl, Isobutyl, Propan-2-on- |
| | ol, Cyclohexanol, Benzyl, Butan-2-on-1-ol, Amyl |
| Esters | Methyl Formate, Methyl Acetate, Methyl Propionate, |
| | Methyl Butyrate, Methyl Crotonate, Ethyl Benzoate, |
| | Methyl Valerate, Methyl Isobutyrate, Cresyl Acetate, |
| | Methyl Palmitate |
| Acids | Formic, Acetic, Glycolic, Propionic, Isobutyric, Benzoic, |
| | Sorbic, Isovaleric, 3-Butenoic, Valeric |
| Carbonyls | Methanal, Propanal, Acetone, Acetol, Diacetyl, |
| | Hydroxyacetaldehyde, Pentanone, Cyclopentanone, |
| | Benzaldehyde, Hexanal |
| Lactones | Butyrolactone, Butenolide, Angelica Lactone, |
| | Hydroxyvalerolactone, 2-Methyl-2-Butenolide, |
| | Methylvinyl-2-Butenolide, 2,3-Dimethyl-2- |
| | Butenolide, 2,3,4-Trimethyl-2-Butenolide, |
| | Crotonolactone, 4-Ethyl-2-Methyl-2-Butenolide |
| Furans | Furfuryl Alcohol, Furans, 2-Methylfuran, 3-Acetylfuran, |
| | Propylfuran, Amylfuran, Benzofuran, 2-Furoic Acid, |
| | 2-Furfural, 5-Methylfurfural |
| Phenols | Diethylphenol, 4-Butylphenol, 4-Propylphenol, |
| | 4-Vinylphenol, 3-Methoxyphenol, Guaiacol, |
| | Pyrocatechol, Isoeugenol, 2,6-Xylenol, Cresol |
| Miscellaneous | Pyrazine, Pyrrole, Pyridine, Maltol, Ethanediol, |
| | Toluene, Styrene, Benzene, Indene, Naphthalene |

Compared to traditional smoking techniques, liquid smoke provides several benefits including quick addition, consistency of the solution, and reproducibility of the final product (Knowles et al., 1975; Suñen et al., 2001). Research has been conducted to evaluate the effects of using liquid smoke in food as an antimicrobial and antioxidant in bacon production (Soares et al., 2016). The antimicrobial activity of liquid smoke has been attributed to phenolic compounds (Faith et al., 1992; Suñen, 1998; Suñen et al., 2001), carbonyl components (Milly et al., 2008; Milly et al., 2005; Montazeri et al., 2013b) and organic acids (Vitt et al. 2001). Wendorff et al. (1993) tested three types of liquid smoke that were manufactured by the Red Arrow company (Manitowoc, WI) for their ability to inhibit the growth of mold on smoked Cheddar cheese. In this experiment, all three types of liquid smoke significantly increased the lag time in the growth of all three molds (Aspergillus oryzae, Penicillium camemberti, and Penicillium roqueforti). In addition, the growth rate of P. camemberti was significantly reduced by the smoke solutions. This mold species (P. camemberti) was identified by Hendrix et al. (2018) as one of the major mold types that grows on the dry-cured ham surface. This mold also serves as shelter and a food source for mites, which contributes to mite growth and infestation (Hubert et al., 2004; Canfield and Wrenn, 2010).

Xanthan gum is a polysaccharide with many industrial uses, including as a common food additive. It is an effective thickening agent, emulsifier, and stabilizer that prevents ingredients from separating. It can be produced from simple sugars using a fermentation process and derives its name from the species of bacteria used, Xanthomonas campestris.

Xanthan gum was discovered by Allene Rosalind Jeanes and her research team at the United States Department of Agriculture, and brought into commercial production by CP Kelco under the trade name Kelzan in the early 1960s.[2][3] It was approved for use in foods in 1968 and is accepted as a safe food additive in the USA, Canada, European countries, and many other countries, with E number E415, and CAS number 11138-66-2.

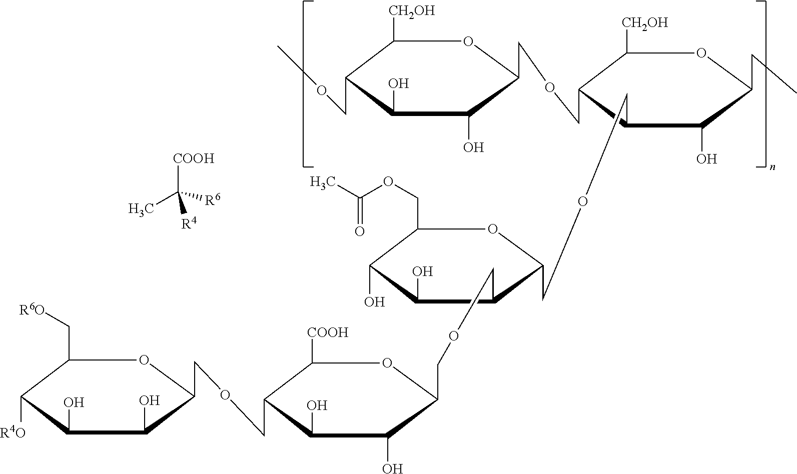

Xanthan gum, 1%, can produce a significant increase in the viscosity of a liquid. In foods, xanthan gum is common in salad dressings and sauces. It helps to prevent oil separation by stabilizing the emulsion, although it is not an emulsifier. Xanthan gum also helps suspend solid particles, such as spices. Xanthan gum helps create the desired texture in many ice creams. Toothpaste often contains xanthan gum as a binder to keep the product uniform. Xanthan gum also helps thicken commercial egg substitutes made from egg whites, to replace the fat and emulsifiers found in yolks. It is also a preferred method of thickening liquids for those with swallowing disorders, since it does not change the color or flavor of foods or beverages at typical use levels. In gluten-free baking, xanthan gum is used to give the dough or batter the stickiness that would otherwise be achieved with gluten. In most foods it is used at concentrations of 0.5% or less. Xanthan gum is used in a wide range of food products, such as sauces, dressings, meat and poultry products, bakery products, confectionery products, beverages, dairy products, and others.

Embodiments of the present invention include providing novel compositions of food-grade coatings that can control pest infestations and reproduction, such as ham mites, and methods of infusing coatings, including the coatings of the invention, into food containers such as wraps and nets. The invention is designed to be used on or with ham, pork, and any food upon which mites typically thrive, as well as on or with cheese and fermented soy food products, for example. The invention further provides composition-treated food containers and methods to infuse compositions into food containers and nets used to store, age, and/or cure such foods.

With the foregoing and other objects, features, and advantages of the present invention that will become apparent hereinafter, the nature of the invention may be more clearly understood by reference to the following detailed description of the preferred embodiments of the invention and to the appended claims.

Therefore, the first object of the presently-disclosed subject matter is to control mite growth on food stuff, particularly aging hams, through the use of liquid smoke in coated ham nets and/or in food grade coatings. Another object of the presently-disclosed subject matter is minimize the sensory perception, water activity, moisture content, and weight loss of dry-cured hams treated with liquid smoke in coated nets and/or food-grade coatings affects.

With the foregoing and other objects, features, and advantages of the present invention that will become apparent hereinafter, the nature of the invention may be more clearly understood by reference to the following detailed description of the preferred embodiments of the invention and to the appended claims.

One embodiment of the invention is a food-grade coating composition for controlling pest infestation and pest reproduction on or in food, or both, wherein the composition comprises mixtures containing liquid smoke and at least one of xanthan gum, propylene glycol, alginate, and/or carrageenan. Preferably, the composition comprises about 1% to about 5% by weight or volume of at least one of xanthan gum, and about 1% to about 5% by weight or volume of liquid smoke.

In another embodiment, the composition is on or infused in a food-grade acceptable carrier for the composition. The carrier can be a wrap or net.

Examples of the food container are bags, wraps, mesh, nets, socks or a combination thereof, that is soaked or infused with the liquid smoke and at least one of xanthan gum.

Examples of the food that can be protected with the present invention include pork, most commonly ham, pork, cheese, fermented soy food product, or a combination thereof, and the pests are mites.

Another embodiment of the invention is a method for controlling pest infestation and pest reproduction on or in food, or both. Aspects of this embodiment include applying a food-grade coating composition on or in the food, or both, for controlling food pests and pest infestations and reproduction on the food; and the composition comprises liquid smoke and at least one of xanthan gum, propylene glycol, alginate, and/or carrageenan.

Another embodiment of the present invention is a container for controlling pest infestation and pest reproduction on or in food, wherein the container has been treated or infused with a food-grade coating composition described herein. the container is a bag, wrap, mesh, net, or a combination thereof, that provides contact with the food.

In another embodiment of the invention, the container has been treated or infused with the food-grade coating composition of claim 1, and sealed for storage. One example of this embodiment is vacuum sealing the infused net for delivery to one preparing for food storage.

Edible coatings have been applied for different purposes on a variety of food products, including fresh fruits and vegetables, confections, and meat products. For meat products, edible films and protective coatings have been used to prevent off-flavor due to oxidation, discoloration, quality loss such as shrinkage, and microbial contamination (Ustunol, 2009). For example, film coatings made from k-carrageenan incorporated with ovotransferrin (a protein of avian egg's antimicrobial defense system) and ethylenediaminetetraacetic acid (EDTA) have been applied on fresh chicken breasts and have shown inhibition against E. coli and total aerobic bacteria during storage (Seol, Lim, Jang, Jo, & Lee, 2009). To be qualified as a coating for dry-cured ham, the compound must: 1) be food-grade; 2) be able to attach to the ham surface; 3) be able to cover the ham surface evenly; 4) be stable during the aging process; 5) be permeable to water vapor and oxygen: 6) be able to suffocate, kill, and/or repel mites and insects when applied properly; 7) not adversely affect ham flavor; and 8) be easily removed after the aging process. The food-grade coatings of the present invention were very effective at controlling mite infestations under laboratory conditions, were permeable to moisture, and did not change the sensory properties of the food or dry-cured ham.

### DESCRIPTION OF EXEMPLARY EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, and other published materials referred to throughout the entire disclosure herein, unless noted otherwise, are incorporated by reference in their entirety.

Although any methods, devices, and materials similar or equivalent to those described herein can be used in the practice or testing of the presently-disclosed subject matter, representative methods, devices, and materials are described herein.

Following long-standing patent law convention, the terms “a”, “an”, and “the” refer to “one or more” when used in this application, including the claims, unless the context clearly dictates otherwise. Thus, for example, reference to “a polypeptide” includes one or more of such polypeptides, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Provided herein are food grade coatings compositions made from generally recognized as safe polysaccharides infused with liquid smoke. In some embodiments, the food grade coating compositions are used to control pests through coating applications of food product surface or packaging that is used to contain the food products.

The presently-disclosed subject matter is further illustrated by the following specific but non-limiting examples. The following examples may include compilations of data that are representative of data gathered at various times during the course of development and experimentation related to the presently-disclosed subject matter.

### Examples

Materials and Methods

Food Grade Coatings Materials

Dry-cured hams (average 6.5-7.5 kg) that were aged for three months were sourced from a commercial ham producer in Tennessee. Ham nets (polyester, with 25 inches stitch length per 200 needles) were provided by Dickson Industries Inc. (Des Moines, IA). Xanthan gum (XG, Pre-Hydrated Ticaxan Rapid-3) was provided by TIC Gums (Belcamp, MD), and food-grade propylene glycol (product number 912752) was purchased from Hawkins Inc. (Roseville, MN). Two liquid smoke products, Charsol Supreme Poly (SP) and Charsol Select 24P (24P), were provided by Red Arrow (Manitowoc, WI).

Ham Cube Preparation

Whole dry-cured hams that had been aged for three months were unwrapped, washed, and sliced (2.5 cm thickness) at the Mississippi State University Meat Science and Muscle Biology laboratory. The slices were vacuum-packaged in Clarity™ 3-Mil vacuum pouches (Bunzl Processor Division, North Kansas City, MO) with an Ultravac® 2100 Double Chamber Vacuum Packaging Machine (Ultrasource LLC, Kansas City, MO) and stored in a walk-in cooler at 2-4° C. until the ham slices were cut into ham cubes (2.5×2.5×2.5 cm³). Five cubes were assigned to each treatment from each ham prior to the coating or infusion of treatment solutions into ham nets.

Solution Preparation

The food-grade coating solution formulas for experiment 1 included: (1) 1% SP+1% XG, (2) 2% SP+1% XG, (3) 1% SP only, (4) 2% SP only, and (5) 1% XG+20% PG. The food-grade coating solution formulas for experiment 2 included: (1) 2% 24P+1% XG, (2) 1% 24P only, (3) 2% 24P only, and (4) 1% XG+20% PG.

To prepare the solution with XG, the XG was first added to the water slowly while stirring using a mini electronic mixer (Good Cook, Rancho Cucamonga, CA). If PG was an ingredient in the treatment, it was then added and stirred with a glass stick. Liquid smoke was then added using an Accu-jet® pro pipette controller (BrandTech Scientific, Inc., Wertheim, Germany), while vigorously mixing the solution. The solutions were prepared the same day that the nets and cubes were coated. Xanthan gum is soluble in both cold and hot water, and the viscosity of its solutions changes very little with temperature (Huber and Bemiller, 2017). Since liquid smoke contains volatile compounds (Montazeri et al., 2013b), selecting polysaccharides that can dissolve in water without heating was more feasible to avoid the potential evaporation of the chemical compounds in the liquid smoke.

Net Coating and Cube Coating

Net pieces (14.5×13 cm²) were fully submerged in the respective solutions for 1 min and squeezed by hand to ensure that the net was covered with the coating. The soaked net pieces were then removed from the treatment solutions and rolled with hand operated rolling pins (Walmart Stores Inc., Bentonville, AR) to squeeze the extra solution gently out of the nets. The target absorbance for the treatment solutions without gum was 2.9-3.4 times the original weight of the net, and for the solution with gum was 5.2-6.8 times the original weight of the net.

The previously cut cubes were randomly selected and five of them were assigned to each group. The net treatments were wrapped around their designated cubes and tied using a cotton string. For direct coating treatments (no net), cubes were then directly dipped into the coating solution for 1 min and then hung in the air on a shelf for 5 min to dry. All netted and coated cubes were individually placed in ventilated glass Mason jars (118 mL, 6.4 cm diameter, 5.7 cm height; Ball Corp., Broomfield, CO). The bottom of each jar was covered with pre-cut black construction paper. The top of each jar was covered with filter paper (Fisherbrand™ P4 Grade filter paper, Ottawa, Canada) to replace the metal jar ring to allow access to oxygen to facilitate mite growth. The sealed jars were stored at 2-4 C.° until the ham cubes were inoculated with mites on the following day.

Mite Reproduction Assay

The mite culture that was used in this experiment was provided by Dr. Thomas Phillip's lab in the Department of Entomology at Kansas State University. The culture was reared as described by Abbar et al. (2016b). The mite culture jar was stored in a plastic tray filled with a basin of dish soap water, and petroleum jelly (Equate brand, Bentonville, AR) was smeared along the rim to prevent mites from escaping the tray if any were to escape their jars. The tray was stored in a dark cabinet at 23±2° C. and 70±5% relative humidity. Twenty mixed-sex mites (at least 12 females) were inoculated on the cubes in ventilated mason jars as described previously. The inoculated jars were stored in an environmental chamber (LH-10 Economy Line Humidity Chamber, 0.28 cubic meter volume, Associated Environmental Systems, Acton, MA) at 24° C. and 75% relative humidity. After two weeks, the jars were taken out, and the mites (live adults and mobile immature stages) that were present on the cubes, black construction paper, nets (if applied), and the inside jar surfaces were counted under a stereomicroscope (Model 568, American Optical Company, Buffalo, NY), and the values were combined to estimate the total mite population growth for each treatment.

Water Activity, Moisture Content and Weight Loss

Simultaneous experiments were conducted as described above in section 2.2, 2.3 and 2.4 in the materials and methods. Non-inoculated ham cubes were used to evaluate water activity (a_{w}), moisture content and weight loss of the numbered ham cubes. The treatment solutions were selected from the solutions that controlled mite growth. After two weeks of storage in the programmed environmental chamber, the jars were removed, and the ham cubes were cut into fine particles using a knife. The water activity of each ham cube was measured at room temperature with a water activity meter (AquaLab Series 3 TE, Decagon Devices, Inc., Pullman, WA). The moisture content of the samples was determined by drying the minced ham sample (2.0±0.1 g) in an Isotemp® oven (Fisher Scientific, Waltham, MA) at 105±2° C. until a constant weight was obtained (AOAC, 2000). A desiccator was used to cool dried samples prior to weighing on an analytical balance (Ohaus, item number E10640, Parsippany, NJ). The moisture content was expressed as a percentage and was calculated using the formula as shown below (AOAC, 2000).

$$Moisture content ( \% ) = \frac{( W 1 - W 2 )}{W 1} \times 100 \qquad ( 3.1 )$$

Where W1=weight of the sample before drying in an oven
W2=weight of the sample after drying in an oven

The weight of each numbered cube was measured both before (Wb) 14 days of aging and after (Wa). The weight loss of the ham cube was calculated as follows (Zhang et al., 2018):

$$Weight loss ( \% ) = \frac{( W b - Wa )}{W b} \times 100 \qquad ( 3.2 )$$

Where Wb=weight of the ham cube before aging
Wa=weight of the ham cube after aging for 14 days

Sensory Evaluation-Difference from Control Test

A difference from control test was used to determine if trained panelists perceived a difference between control ham samples and treated samples (Campbell et al., 2017; Civille & Carr, 2015). The treatment solutions were selected based on their efficacy at controlling mites. The coating solution and ham slices were prepared as mentioned previously. All coating solutions were made in 400 ml batches. Center slices of each ham were selected and wrapped with treated nets or wrapped with the untreated original DK 409 net, or with no net wrapped. Food-grade net socks (Dickson Inc., Des Moines, IA) were cut from factory rolls so that they were 15 cm wide×30 cm length. The pre-cut net socks were then soaked into the assigned coating solution for 1 min to fully absorb the coating solution. Each ham slice was placed into the randomly assigned net sock individually. The open ends of the net were sealed with a cotton string. The sealed net with the ham slices inside were laid on a cutting board to allow excess coating to drain from the net. After 20 min, the slices were put into zip-loc bags and sealed (Great Value, Walmart Inc., Bentonville, AR) and stored at 4° C. for 14 d.

Before cooking, ham slices were equilibrated to ambient temperature. Each ham slice was rinsed with tap water at room temperature and then wrapped in heavy-duty aluminum foil (Reynolds Wrap, Reynolds Kitchens, Richmond, VA). Wrapped slices were then baked in an oven (Viking Range LLC., Model #VGRC605-6G-SS, Greenwood, MS) at 177° C. to an internal temperature of 71° C. that was verified using a digital thermometer (Winco TMT-DG6, Winco food, Boise, Idaho; Marriott and Ockerman, 2004). After baking, the slices rested for 5-10 min prior to transfer to a cutting board. Ham slices were then cut into rectangular pieces (1.3×1.3×2.5 cm³) from the same muscle category for each treatment that was served to individual panelists to avoid sensory variability among muscles. Upon serving, ham pieces were placed into 29.5 ml clear plastic containers (Dart Container Corporation, Mason, MI) and coded with 3-digit random numbers.

Samples were provided to the trained panelists (n=6) with purified water, apple juice (Great Value, Walmart Inc., Bentonville, AR), napkins, forks, plates, expectorant cups, and unsalted crackers (Great Value, Walmart Stores Inc., Bentonville, AR) in separate tasting booths. A labeled control sample and blind control with a 3-digit random number were included in each test as baselines for all blind coded samples and coating treated samples, respectively. Trained panelists, each with greater than 30 h of experience in evaluating dry-cured ham, were asked to evaluate the labeled control sample first and then rate how different the treatment samples were from the control with respect to flavor, texture, and moistness. The scale for the difference from control test was: 0=no difference, 1=slight difference, 2=moderate difference, 3=large difference, 4=very large difference (Civille and Carr, 2015).

Statistical Analysis

For mite growth experiments, a randomized complete block design with two replications and five subsamples was used to determine the effect of different treatments on ham mite reproduction. A randomized complete block design with two replications and three subsamples was used to determine the effect of different treatments on water activity, moisture content and weight loss. For all experiments related to sensory evaluation, a randomized complete block design with three replications and six subsamples of each replication was used to determine if trained panelists detected a difference between treated and control hams (P<0.05). Difference from control test data collection was performed using Compusense software (Compusense Cloud, Guelph, CA). When significant differences (P<0.05) occurred among treatments, Duncan's new multiple range test was used to separate treatment means.

Results and Discussion

Mite Counts

As seen in previous research by Campbell et al. (2018) and Zhang et al. (2018), the net only treatment reduced mite counts on ham cubes in comparison to the negative control with no net (Table 1). However, with 100 mites, the net alone was ineffective at controlling mites, since this number is greater than the inoculation level of 20. The use of 1% SP liquid smoke mixed with 1% XG controlled mite growth both as a coating and in a coated net (F_{10,10}=30.12, P<0.0001) since the mite count was less than 20 and was less (P<0.05) than the net control. The addition of 2% SP into 1% XG (2% SP+1% XG treatment) did not control mite growth when coated on ham cubes (NS) in comparison to the net control, but controlled mites when infused in the net and wrapped on cubes. Although applying SP only (1% and 2%) did not (NS) control mite growth in both coatings and nets, the use of the net infused with SP (1% and 2%)+1% XG controlled mite growth. This shows that xanthan gum with SP could potentially be used as an alternative to propylene glycol in coated nets. It was also interesting that 2% SP seemed desirable to the mites if used as a direct coating. The addition of liquid smoke Charsol 24P controlled mite growth when used at 2% with 1% XG (Table 2), whether used in a coating or a coated net treatment (F_{8,8}=8.11, P=0.0039). Coating 1% and 2% 24P on the ham cube surface did not control mite growth when compared to both the control and net control. However, when the 1% or 2% 24P solution was infused into the net, they both controlled mite growth, as evidenced by the mite counts being less than 20. This indicated that the liquid smoke 24P could be used in nets both with and without xanthan gum in the place of propylene glycol in coated nets.

TABLE 1
Mean number of mites on inoculated ham cubes (20 mites/cube,
n_{cube} = 5) coated with liquid smoke Charsol
Supreme Poly (SP) and xanthan gum after 2 wks incubation
at 25° C. and 75% relative humidity.

| Treatments¹ | Mean |
|---|---|
| Negative control (no net) | 228.2 ± 24.6 ^{b} |
| Negative control (net) | 100 ± 17.2 ^{c} |
| 1% SP + 1% XG (no net) | 19.4 ± 6.3^{d} |
| 1% SP + 1% XG (net) | 12.5 ± 4.4^{d} |
| 2% SP + 1% XG (no net) | 32.6 ± 9.7^{cd} |
| 2% SP + 1% XG (net) | 8.2 ± 2.9^{d} |
| 1% SP only (no net) | 282.7 ± 45.5^{ab} |
| 1% SP only (net) | 60.3 ± 9.7^{cd} |
| 2% SP only (no net) | 312.4 ± 25.0^{a} |
| 2% SP only (net) | 41.4 ± 4.1 ^{cd} |
| 1% XG + 20% PG (net) | 0^{d} |

^{a-d}Means with the same letter within each column are not significantly (NS) different using Duncan's New Multiple Range Test.
¹Control ham cubes was not coated; XG: xanthan gum; PG: propylene glycol; SP: liquid smoke Charsol Supreme Poly.

TABLE 2
Mean number of mites on inoculated ham cubes (20 mites/cube,
n_{cube} = 5) coated with liquid smoke Charsol 24P and xanthan
gum after 2 wk incubation at 25° C. and 75% relative humidity.

| Treatment¹ | Mean NO. of mites |
|---|---|
| Negative control (no net) | 253.8 ± 42.9^{a} |
| Negative control (net) | 105.7 ± 18.0^{bc} |
| 2% 24P + 1% XG (no net) | 0.8 ± 0.5^{c} |
| 2% 24P + 1% XG (net) | 1.5 ± 1.4^{c} |
| 2% 24P only (no net) | 175.5 ± 37.4^{ab} |
| 2% 24P only (net) | 9.4 ± 3.6^{c} |
| 1% 24P only (no net) | 163.4 ± 15.3^{ab} |
| 1% 24P only (net) | 4.6 ± 1.6^{c} |
| 1% XG + 20% PG (net) | 0^{c} |

^{a-c}Means with the same letter within each column are not significantly (NS) different using Duncan's New Multiple Range Test.
¹Control ham cubes was not coated; XG: xanthan gum; PG: propylene glycol; 24P: liquid smoke Charsol Select 24P

Four stages are involved in the pyrolysis of wood, which leads to the formation of carboxylic acids, carbonyl compounds and phenolic compounds (Ramakrishnan and Moeller, 2002; Šimko, 2005). Phenolic compounds (Faith et al., 1992; Suñen, 1998; Suñen et al., 2001), carbonyl components (Milly et al., 2008; Milly et al., 2005; Montazeri et al., 2013b) and organic acids (Vitt et al. 2001) contribute to the antimicrobial activity of liquid smoke. Liquid smoke is effective at controlling Listeria (Martin et al., 2010; Messina et al., 1988; Pittman et al., 2012), Salmonella (Kim et al., 2012; Van Loo et al., 2012) and E. coli growth (Estrada-Munoz et al., 1998; Fretheim et al., 1980; Van Loo et al., 2012). The concentration of phenolic compounds in liquid smoke is 9.9-11.1 mg/ml (Ramakrishnan and Moeller, 2002), and the carbonyl concentration is 2.6-4.6% (Milly et al., 2005). Suñen (1998) used seven commercial smoke condensates (four liquid types and three solid types) and tested their antimicrobial activity in vitro. The most effective condensate at the level tested possessed a high concentration of phenols, but acetic acid was the most concentrated compound. The author suggested that this condensate's antimicrobial ability may be due to the synergistic reaction between phenols and acetic acid (Faith et al., 1992; Suñen, 1998). Further tests that were conducted by the author (Suñen et al., 2001) indicated that liquid smoke's phenol concentration is not directly correlated with its antimicrobial activity.

Some liquid smoke products from Red Arrow company (Manitowoc, WI) were evaluated for their antimicrobial and more specifically their antifungal effectiveness. In these studies, Wendorff (1981) used several types of liquid smoke from Red Arrow company (Manitowoc, WI), and 0.25% (v/v) CharSol C-6 decreased Staphylococcus aureus growth by 72%. Wendorff et al. (1993) also tested three types of liquid smoke for their ability to inhibit the growth of mold on smoked Cheddar cheese. In this experiment, all three types of liquid smoke increased the lag time in the growth of all three molds (Aspergillus oryzae, Penicillium camemberti, and Penicillium roqueforti). The growth rate of P. camemberti was significantly reduced by the smoke solutions. This mold species (P. camemberti) was identified by Hendrix et al. (2018) as one of the major types of mold that grow on the surface of dry-cured hams. The growth of Penicillium spp. is undesirable during dry-cured ham aging because they can generate off-flavor, off-odors and contribute to health issues for workers who are allergic to Penicillium (Asefa et al., 2009). Some species of mold also function as shelter for mites and provide food and water for mites (Hubert et al., 2004; Canfield and Wrenn, 2010). Per the manufacturer, 24P has less acetic acid but more carbonyl compounds than SP, and a similar concentration of phenolic compounds.

The individual components of liquid smoke are evaluated to determine their efficacy at controlling mites. In particular, liquid smokes, 24P and SP, help control mites due to their antimicrobial properties, which control mold and thus limit the mites' accessibility to food and water.

Sensory Evaluation-Difference from Control

There were no sensory differences (Table 3) between liquid smoke SP treated sample and blind control samples with respect to texture (F_{3, 61}=2.26, P=0.025), flavor (F_{3, 61}=1.00, P=0.456) and moistness (F_{3, 61}=1.68, P=0.105). No sensory differences were detected (Table 4) between 24P treated sample and blind control samples with respect to texture (F_{4, 78}=0.93, P=0.520) and flavor (F_{4, 78}=1.19, P=0.311). Significant difference was found with respect to moistness (F_{4,78}=3.04, P=0.002) when slices were treated with 2% 24P+1% XG solution infused nets compared to that of blind control. None of the liquid smoke treated ham slices were rated above 2 on average (2=moderately different).

TABLE 3
Sensory differences in texture, flavor, and moistness of
2.5 cm thick ham slices that were wrapped in saturated nets
with solutions containing liquid smoke Charsol ®
Supreme Poly and different gums using a 5-point difference
from control test (n = 6) after 14 days of storage at 2-4° C.

| Treatment¹ | Texture² | Flavor | Moistness |
|---|---|---|---|
| Blind Control | 1.00 ± 0.24 | 1.44 ± 0.23 | 0.94 ± 0.17 |
| 1% SP + 1% XG (net) | 1.05 ± 0.24 | 2.05 ± 0.29 | 1.05 ± 0.19 |
| 2% SP + 1% XG (net) | 1.33 ± 0.19 | 1.83 ± 0.23 | 1.17 ± 0.18 |
| 1% XG + 20% PG (net) | 1.56 ± 0.23 | 1.61 ± 0.28 | 1.44 ± 0.23 |

¹XG: xanthan gum; SP: liquid smoke Charsol Supreme Poly.
²Scale for difference from control test- 0 = no difference, 1 = slight difference, 2 = moderate difference, 3 = large difference, 4 = very large difference

TABLE 4
Sensory differences in texture, flavor, and moistness of
2.5 cm thick ham slices that were wrapped in saturated nets
with solutions containing liquid smoke Charsol ®
Select 24P and different gums using a 5-point difference
from control test (n = 6) after 14 days of storage at 2-4° C.

| Treatment¹ | Texture² | Flavor | Moistness |
|---|---|---|---|
| Blind Control | 1.11 ± 0.24 | 1.27 ± 0.25 | 0.94 ± 0.15^{b} |
| 2% 24P + 1% XG (net) | 1.56 ± 0.26 | 1.61 ± 0.30 | 1.56 ± 0.27^{a} |
| 2% 24P (net) | 0.94 ± 0.26 | 0.88 ± 0.17 | 0.66 ± 0.18^{b} |
| 1% 24P (net) | 1.11 ± 0.24 | 1.44 ± 0.27 | 0.94 ± 0.18^{b} |
| 2% 24P + 1% XG (coating) | 1.16 ± 0.25 | 1.50 ± 0.27 | 0.94 ± 0.25^{b} |

^{a-b}Means with the same superscript in a column indicate no difference (P > 0.05).
¹XG: xanthan gum. 24P: liquid smoke Charsol Select 24P.
²Scale for difference from control test- 0 = no difference, 1 = slight difference, 2 = moderate difference, 3 = large difference, 4 = very large difference

As indicated above, a pharmacist from Kansas invented a liquid smoke flavor from primary smoke condensate in the late 19th century for curing hams and bacon at home (Pszczola, 1995; Simon et al., 2005). The application of liquid smoke provides several benefits including quick addition, controllability, consistency of the solution, and reproducibility of the final product (Knowles et al., 1975; Suñen et al., 2001). The highly concentrated nature of liquid smoke makes it advantageous for use in sauces or brines or topical applications to meat products, including frankfurters, ham, sausages, and bacon (Lingbeck et al., 2014; Rozum, 2009). A wide range of products use liquid smoke as an ingredient including meats, cheeses, tofu, and pet foods.

It is appropriate to use the difference from control test when heterogeneous products such as dry-cured meat products (Civille and Carr, 2015). The test was used in Rogers et al. (2020) research to determine if using C₈C₉C₁₀ fatty acids to coat dry-cured ham slices directly or indirectly (on net) caused sensory differences when compared to untreated dry-cured ham slices. Results from direct coating experiments indicated that differences in texture, flavor and moistness were caused by applying 1% XG+10% C₈C₉C₁₀ and 1% carrageenan (CG)+1% propylene glycol alginate (PGA)+10% C₈C₉C₁₀. In indirect (on net) experiments, differences in texture, flavor and moistness were detected between the untreated control and soybean oil+10% C₈C₉C₁₀ and CG+PGA+10% C₈C₉C₁₀ treatments. No difference in texture was detected when 1% XG+10% C₈C₉C₁₀ treatment was applied. Differences in that study were likely due to the volatile nature of the octanoic, nonanoic, and decanoic acids, which impart flavor to the ham. Liquid smoke also contains volatile flavor compounds (Guillén and Ibargoitia, 1996), including phenols which impart smoke flavors. In the current research, the only statistical difference was found for treatment 2% 24P+1% XG (in net) with respect to moistness when compared to the blind control. This could potentially be due to the solution stabilizing effect of xanthan gum which prevented moisture from evaporating in the ham cube (Huber and Bemiller, 2017).

Different types of overall different tests were used in research related to liquid smoke. Montazeri et al. (2013a) used four types of liquid smoke produced from Kerry Ingredients and Flavors (Monterey, TN) to test their listericidal effects and conducted a simple difference test. In the simple difference test, thirty-six cold-smoked salmon fillets were treated with AM-3 liquid smoke (Kerry Ingredients and Flavors, Monterey, TN) and the other thirty-six cold-smoked salmon (control) were not treated with liquid smoke. The simple difference test results indicated that panelists could not differentiate the control from the liquid smoke treated samples. Nithin et al. (2016) used liquid smoke that was pyrolyzed from coconut husk to evaluate its effect in Masmin (a smoked and dried product prepared from skipjack tuna) production. A difference-from-control test was conducted as described by Civille and Carr (2015), and results indicated that the soaking of cooked skipjack tuna in liquid smoke for 30 min can produce Masmin with similar sensory attributes to traditional Masmin which is smoked and dried.

The use of both types of liquid smoke in current research did not cause significant differences in flavor and texture compared to the untreated control, and no ratings were greater than 2. Therefore, the liquid smoke has the potential to be used during dry-cured ham aging without affecting the sensory attributes of the final product.

Water Activity (Aw), Moisture Content and Weight Loss

The a_{w} of treatments with 1% SP+1% XG and 2% SP+1% XG were greater than control and net control ham cubes (F_{4, 24}=9.79, P<0.0001), but there were no differences in a_{w} between the liquid smoke and PG treatments with 1% XG (Table 5). Ham cubes netted with 1% SP+1% XG, 2% SP+1% XG and 1% XG+20% PG had greater (P<0.05) moisture content than the control (F_{4, 24}=3.14, P<0.0328), but were not (NS) different (P>0.05) from the net control. No statistical differences (NS) were detected when the weight loss of the 1% SP+1% XG and 2% SP+1% XG treatment nets to that of control and net control (F_{4, 24}=2.24, P=0.0949).

TABLE 5
Water activity (a_{w}), moisture content and weight loss of dry cured
ham cubes wrapped with different treated nets after 2 weeks of
storage at 23 ± 2° C. and relatively humidity of 75 ± 5%.

| | | Moisture content | |
|---|---|---|---|
| Treatments¹ | Water activity | (%) | Weight loss (%) |
| Control | 0.866 ± 0.009 ^{b} | 49.4 ± 2.28 ^{b} | 18.2 ± 3.0 |
| Net control | 0.878 ± 0.124 ^{b} | 52.4 ± 1.53 ^{ab} | 21.5 ± 1.9 |
| 1% SP + 1% | 0.906 ± 0.007 ^{a} | 57.4 ± 1.81 ^{a} | 15.6 ± 2.1 |
| XG (net) | | | |
| 2% SP + 1% | 0.909 ± 0.003 ^{a} | 55.7 ± 1.78 ^{a} | 15.7 ± 2.1 |
| XG (net) | | | |
| 1% XG + 20% | 0.919 ± 0.004 ^{a} | 56.4 ± 1.89 ^{a} | 11.5 ± 2.7 |
| PG (net) | | | |

^{a-b} Means with same letter within each column are not different (P > 0.05) using Duncan's New Multiple Range test.
¹XG: xanthan gum, PG: propylene glycol; SP: liquid smoke Charsol Supreme Poly.

Treatments that included liquid smoke 24P had greater a_{w} (F_{5, 29}=25.07, P<0.0001) than that of the control and net control (Table 6). In addition, when 2% 24P and 1% XG were used as ingredients, the a_{w} of ham cubes was greater than (P<0.05) ham cubes that were treated with 1% 24P. The 2% 24P net treatment did not differ (NS) in a_{w} when compared to the 1% 24P net. When 24P was used, the 2% 24P+1% XG net treatment contained more moisture (P<0.05) than the control and net control (F_{5, 29}=2.96, P=0.0279). All other treatments (coating 2% 24P+1% XG, net 2% 24P and net 1% 24P) did not differ (NS) in moisture content when compared to the control. The weight loss of all treatments was not different (NS) from the control (F_{5, 29}=3.20, P=0.0201). The ham cubes that were coated with 2% 24P+1% XG had greater (P<0.05) weight loss than ham cubes in the coated net with 2% 24P+1% XG. When nets were used, adding XG to 24P did not affect (NS) the weight loss of ham cubes in comparison to ham cubes treated only with 24P.

TABLE 6
Water activity (aw), moisture content and weight loss of dry cured
ham cubes wrapped with different treated nets after 2 weeks of
storage at 23 ± 2° C. and relatively humidity of 75 ± 5%.

| | | Moisture content | |
|---|---|---|---|
| Treatments¹ | Water activity | (%) | Weight loss (%) |
| Control | 0.872 ± 0.005 ^{c} | 51.4 ± 0.8 ^{bc} | 16.9 ± 1.6 ^{abc} |
| Net control | 0.858 ± 0.006 ^{d} | 50.3 ± 1.2 ^{c} | 21.4 ± 2.0 ^{ab} |
| 2% 24P + 1% | 0.905 ± 0.005 ^{a} | 53.1 ± 2.2 ^{abc} | 23.4 ± 4.7 ^{a} |
| XG (coating) | | | |
| 2% 24P + 1% | 0.899 ± 0.003 ^{a} | 57.3 ± 1.0 ^{a} | 13.9 ± 2.0 ^{c} |
| XG (net) | | | |
| 2% 24P (net) | 0.895 ± 0.003 ^{ab} | 55.7 ± 1.8 ^{ab} | 14.5 ± 1.6 ^{c} |
| 1% 24P (net) | 0.888 ± 0.008 ^{b} | 52.2 ± 1.7 ^{bc} | 16.4 ± 2.8 ^{bc} |

^{a-d} Means with same letter within each column are not different (P > 0.05) using Duncan's New Multiple Range test.
¹XG: xanthan gum; 24P: liquid smoke Charsol 24P.

The a_{w} value of all ham cubes decreased compared to the ham cubes original a_{w} value before the two weeks of incubation (a_{w}=0.923 on average). Mikel and Newman (2002) conducted a basket survey on thirty-eight various country-cured ham products with their pH, a_{w}, salt percentage, and moisture/protein ratio measured. The a_{w} values ranged from 0.74 to 0.93 with an average of 0.88. USDA-FSIS requires country ham processors to monitor water activity to not more than 0.92 when nitrite or nitrate is not used (USDA-FSIS, 9 CFR 319.106, 2021). Ham cube treatments in nets with 1% SP+1% XG and 2% SP+1% XG exhibited greater (P<0.05) a_{w} than control and net control ham cubes but did not exceed the market range of 0.74 to 0.93 (Mikel and Newman, 2002).

In contrast to a_{w}, the moisture content and weight loss of ham cubes in the nets with 1% SP+1% XG and 2% SP+1% XG did not differ from the net control. This indicates that the xanthan gum still allowed moisture loss but did not lower water activity due to the functionality of the xanthan gum. The treatments with 24P have significantly higher a_{w} than that of control and net control. However, all water activities are within the normal market value range of 0.74 to 0.93 (Mikel and Newman, 2002). The ham cubes in the 2% 24P+1% XG net treatment has greater moisture content than the control and net control. This is reasonable since XG slows moisture migration from the meat (Huber and Bemiller, 2017) and keeps the liquid smoke solutions on the nets longer. All treatments with 24P cause the ham cubes to lose similar weight (NS) to the control. This might support that using the solution designed in current research in the aging house will not cause insufficient weight loss. USDA FSIS requires all aged hams to lose at least 18% of their original weight to be legally sold in the market (USDA-FSIS, 9 CFR 319.106, 2021).

Food-grade coatings of XG+PG and CG+PGA+PG were used by Hendrix et al. (2018) to evaluate the effects of temperature (24, 28 and 32° C.) and relative humidity (RH, 55, 65, 75 and 85%) on controlling T. putrescentiae. Minimal differences were found in a_{w} when nets were coated with XG+PG or CG+PGA+PG in similar environmental conditions to those in the current study (24° C. and 75% RH). Zhang et al. (2018) used netting infused with food-grade ingredients, including lard, PGA+CG or XG, and PG, to wrap ham cubes and measured the change in a_{w} after 4-wks and 8-wks of storage. Their results indicated that the a_{w} value in the net control was less compared to that of treatments containing gum, lard, and PG after 4-wks of storage. In the future, the current liquid smoke treatments with XG can be scaled up in commercial aging facilities to evaluate a_{w}, moisture content and weight loss to determine if yields will be increased, leading to more profits, and to verify that the product is still safe, based on either having a water activity of 0.92 or the use of sodium nitrate and the loss of at least 18% of its moisture.

In summary, the addition of 1% or 2% SP to 1% XG to ham nets controlled mite growth. The use of 2% 24P with 1% XG also controlled mite growth when used as either a coating or a coated netting. Using 1% 24P or 2% 24P alone and infused in nets controlled mite growth. In addition, liquid smoke did not cause differences in texture, flavor and moistness, with the exception of 2% 24P+1% XG treatment, which only differed in moistness. SP and 24P treatments had similar (NS) weight loss when compared with the control, indicating that yields would not be impacted by using liquid smoke. In future work, liquid smoke added treatments should be scaled up and tested in ham aging facilities to confirm their efficacy at controlling mites in real world applications.

The above detailed description is presented to enable any person skilled in the art to make and use the invention. Specific details have been revealed to provide a comprehensive understanding of the present invention and are used for explanation of the information provided. These specific details, however, are not required to practice the invention, as is apparent to one skilled in the art. Descriptions of specific applications, analyses, and calculations are meant to serve only as representative examples. Various modifications to the preferred embodiments may be readily apparent to one skilled in the art, and the general principles defined herein may be applicable to other embodiments and applications while still remaining within the scope of the invention. There is no intention for the present invention to be limited to the embodiments shown and the invention is to be accorded the widest possible scope consistent with the principles and features disclosed herein.

While various embodiments of the present invention have been described above, it should be understood that they have been presented by way of example and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

The compositions, processes, systems, and methods of the present invention are often best practiced by empirically determining the appropriate values of the operating parameters, or by conducting simulations to arrive at best design for a given application. Accordingly, all suitable modifications, combinations, and equivalents should be considered as falling within the spirit and scope of the invention.

### REFERENCES

Abbar, S., Amoah, B., Schilling, M. W., Phillips, T. W., 2016a. Efficacy of selected food-safe compounds to prevent infestation of the ham mite, Tyrophagus putrescentiae (Schrank) (Acarina: Acaridae), on southern dry-cured hams. Pest Manag. Sci. 72, 1604-1612. https://doi.org/10.1002/ps.4196
Abbar, S., Schilling, M. W., Phillips, T. W., 2016b. Time-Mortality Relationships to Control Tyrophagus putrescentiae (Sarcoptiformes: Acaridae) Exposed to High and Low Temperatures. J. Econ. Entomol. 109, 2215-2220. https://doi.org/10.1093/jee/tow159
AOAC, 2000. Determination of moisture content—AOAC Official Methods of Analysis. 17th Edition. Gaithersburg, MD.
Armentia, A., Fernandez, A., Perez-Santos, C., De la Fuente, R., Sanchez, P., Sanchis, F., Mendez, J., Stolle, R., 1994. Occupational allergy to mites in salty ham, chorizo and cheese. Allergol. Immunopathol. (Madr). 22, 152.
Asefa, D. T., Gjerde, R. O., Sidhu, M. S., Langsrud, S., Kure, C. F., Nesbakken, T., Skaar, I., 2009. Moulds contaminants on Norwegian dry-cured meat products. Int. J. Food Microbiol. 128, 435-439. https://doi.org/10.1016/J.Ijfoodmicro.2008.09.024
Boczek, J., 1991. Mite pests in stored food. Ecol. Manag. food Ind. pests. Arlingt. FDA Tech. Bull. 4, 57-79.
Bond, E. J., 1984. Manual of fumigation for insect control. pp. 78-103.
Campbell, Y. L., Zhang, X., Shao, W., Williams, J. B., Kim, T., Goddard, J., Abbar, S., Phillips, T. W., Schilling, M. W., 2018. Use of nets treated with food-grade coatings on dry-cured ham to control Tyrophagus putrescentiae infestations without impacting sensory properties. J. Stored Prod. Res. 76, 30-36.
Campbell, Y. L., Zhao, Y., Zhang, X., Abbar, S., Phillips, T. W., Schilling, M. W., 2017. Mite Control and Sensory Evaluations of Dry-Cured Hams with Food-Grade Coatings. Meat Muscle Biol. 1, 100-108.
Canfield, M. S., Wrenn, W. J., 2010. Tyrophagus putrescentiae mites grown in dog food cultures and the effect mould growth has on mite survival and reproduction. Vet. Dermatol. 21, 58-63.
Civille, G. V., Carr, B. T., 2015. Sensory evaluation techniques. CRC Press, pp. 79-81. 108-110.
Cunnington, A. M., 1969. Physical limits for complete development of the copra mite, Tyrophagus putrescentiae (Schrank)(Acarina: Acaridae), in: Proceedings of the 2nd International Congress of Acarology. pp. 241-248.
Estrada-Munoz, R., Boyle, E. A. E., Marsden, J. L., 1998. Liquid smoke effects on Escherichia coli o157:h7, and its antioxidant properties in beef products. J. Food Sci. 63, 150-153. https://doi.org/10.1111/j.1365-2621.1998.tb15697.x
Faith, N. G., Yousef, A. E., Luchansky, J. B., 1992. Inhibition Of Listeria Monocytogenes By Liquid Smoke And Isoeugenol, A Phenolic Component Found In Smoke. J. Food Saf. 12, 303-314. https://doi.org/10.1111/j.1745-4565.1992.tb00086.x
FDA, 2021. 21 CFR 184.1666, https://www.ecfr.gov/current/title-21/chapter-I/subchapter-B/part-184/subpart-B/section-184.1666 (accessed on 10/28/21).
Fields, P. G., 1992. The control of stored-product insects and mites with extreme temperatures. J. Stored Prod. Res. 28, 89-118.
Fields, P. G., White, N. D. G., 2002. Alternatives to methyl bromide treatments for stored-product and quarantine insects. Annu. Rev. Entomol. 47, 331-359.
Fretheim, K., Granum, P. E., Vold, E., 1980. Influence of generation temperature on the chemical composition, antioxidative, and antimicrobial effects of wood smoke. J. Food Sci. 45, 999-1002. https://doi.org/10.1111/j.1365-2621.1980.tb07497.x
Garcia, N., 2004. Efforts to control mites on Iberian ham by physical methods. Exp. Appl. Acarol. 32, 41-50.
Guillén, M. D., Ibargoitia, M. L., 1996. Volatile components of aqueous liquid smokes from vitis viniferal shoots and fagus sylvatical wood. J. Sci. Food Agric. 72, 104-110.
Gulati, R., Mathur, S., 1995. Effect of eucalyptus and mentha leaves and curcuma rhizomes on Tyrophagus putrescentiae (Schrank)(Acarina: Acaridae) in wheat. Exp. Appl. Acarol. 19, 511-518.
Hanson, D. J., Rentfrow, G., Schilling, M. W., Mikel, W. B., Stalder, K. J., Berry, N. L., 2014. US products-dry-cured hams, Handbook of fermented meat and poultry: second edition. Wiley Blackwell, Department of Food, Bioprocessing and Nutrition Sciences, North Carolina State University. https://doi.org/10.1002/9781118522653.ch40
Hendrix, J. D., Zhang, X., Campbell, Y. L., Zhang, L., Siberio, L., Cord, C. L., Silva, J. L., Goddard, J., Kim, T., Phillips, T. W., Schilling, M. W., 2018. Effects of temperature, relative humidity, and protective netting on Tyrophagus putrescentiae (Schrank) (Sarcoptiformes: Acaridae) infestation, fungal growth, and product quality of dry cured hams. J. Stored Prod. Res. https://doi.org/10.1016/j.jspr.2018.05.005
Huber, K. C., BeMiller, J. N., 2017. Chapter 3., Carbohydrates. Fennema's Food Chemistry. Damodaran, S., Parkin, K. L., CRC Press, pp. 152-154.
Hubert, J., Stejskal, V., Munzbergova, Z., Kubatova, A., Vañovà, M., Žd'árková, E., 2004. Mites and fungi in heavily infested stores in the Czech Republic. J. Econ. Entomol. 97, 2144-2153.
Kim, S. P., Kang, M. Y., Park, J. C., Nam, S. H., Friedman, M., 2012. Rice hull smoke extract inactivates Salmonella typhimurium in laboratory media and protects infected mice against mortality. J. Food Sci. 77, M80-M85. https://doi.org/10.1111/j.1750-3841.2011.02478.x
Knowles, M. E., Gilbert, J., McWeeny, D. J., 1975. Phenols in smoked cured meats. Phenolic composition of commercial liquid smoke preparations and derived bacon. J. Sci. Food Agric. 26, 189-196.
Lingbeck, J. M., Cordero, P., O'Bryan, C. A., Johnson, M. G., Ricke, S. C., Crandall, P. G., 2014. Functionality of liquid smoke as an all-natural antimicrobial in food preservation. Meat Sci. https://doi.org/10.1016/j.meatsci.0.2014.02.003
Marriott, N. G., Ockerman, H. W., 2004. The Ultimate Guide to Country Ham: An American Delicacy. Brightside Press. Radford, VA
Marriott, N. G., Schilling, M. W., 2004. Dry cured pork research review, in: White Paper. National Country Ham Association, Inc. National Country Ham Association Annual Meeting. pp. 1-62.
Martin, E. M., O'Bryan, C. A., Lary, R. Y., Griffis, C. L., Vaughn, K. L. S., Marcy, J. A., Ricke, S. C., Crandall, P. G., 2010. Spray application of liquid smoke to reduce or eliminate Listeria monocytogenes surface inoculated on frankfurters. Meat Sci. 85, 640-644. https://doi.org/10.1016/j.meatsci.0.2010.03.017
Messina, M. C., Ahmad, H. A., Marchello, J. A., Gerba, C. P., Paquette, M. W., 1988. The Effect of Liquid Smoke on Listeria monocytogenes. J. Food Prot. 51, 629-631. https://doi.org/10.4315/0362-028X-51.8.629
Mikel, W. B., Newman, M., 2002. Development of appropriate intervention methods to reduce the occurrence of pathogenic bacteria on country-cured hams, USDA-FSIS, Listeria Interventions for Country Hams. [C-20]. URL: https://www.fsis.usda.gov/sites/default/files/media file/2020-09/New_Technology_C-20_Abstract_2003.pdf
Milly, P. J., Toledo, R. T., Chen, J., 2008. Evaluation of liquid smoke treated ready-to-eat (RTE) meat products for control of Listeria innocua M1. J. Food Sci. 73, M179-M183.
Milly, P. J., Toledo, R. T., Ramakrishnan, S., 2005. Determination of minimum inhibitory concentration of liquid smoke fractions. J. Food Sci. 70, M12-M17. https://doi.org/10.1111/j 0.1365-2621.2005.tb09040.x
Montazeri, N., Himelbloom, B. H., Oliveira, A. C. M., Leigh, M. B., Crapo, C. A., 2013a. Refined liquid smoke: a potential antilisterial additive to cold-smoked sockeye salmon (Oncorhynchus nerka). J. Food Prot. 76, 812-819. https://doi.org/10.4315/0362-028X.JFP-12-368
Montazeri, N., Oliveira, A. C. M., Himelbloom, B. H., Leigh, M. B., Crapo, C. A., 2013b. Chemical characterization of commercial liquid smoke products. Food Sci. Nutr. 1, 102-115.
Mueller, D. K., Kelley, P. J., VanRyckeghem, A. R., 2006. Mold mites Tyrophagus putrescentiae (Shrank) in stored products, in: 9th International Working Conference on Stored Product Protection. p. 1122.
Nithin, C. T., Yathavamoorthi, R., Chatterjee, N. S., Ananthanarayanan, T. R., Mathew, S., Bindu, J., Srinivasa Gopal, T. K., 2016. Assessment of efficiency of an indigenous liquid smoke for masmin production 53(2), 110-114.
Osteen, C., 2003. Methyl bromide phaseout proceeds: Users request exemptions. Amber Waves 1, 23-27.
Pittman, J. R., Schmidt, T. B., Corzo, A., Callaway, T. R., Carroll, J. A., Donaldson, J. R., 2012. Effect of stressors on the viability of Listeria during an in-vitro cold-smoking process. Agric. Food Anal. Bacteriol 2, 195-208.
Pszczola, D. E., 1995. Tour highlights production and uses of smoke-based flavors. Food Technol. 49 (1), 70-74.
Ramakrishnan, S., Moeller, P., 2002. Liquid smoke: product of hardwood pyrolysis. Fuel Chem. Div. Prepr. 47, 366.
Rentfrow, G., Chaplin, R., Suman, S. P., 2012. Technology of dry-cured ham production: Science enhancing art. Anim. Front. 2, 26-31.
Rogers, W., Campbell, Y. L., Zhang, X., Shao, W., White, S., Phillips, T. W., Schilling, M. W., 2020. The application of food grade short chain fatty acids to prevent infestation of Tyrophagus putrescentiae on dry cured ham and the effects on sensory properties. J. Stored Prod. Res. 88, 101684. https://doi.org/10.1016/j.jspr.2020.101684
Rozum, J. J., 2009. Smoke flavor, in: Ingredients in Meat Products: Properties, Functionality and Applications. Springer New York, Red Arrow International, LLC, pp. 211-226. https://doi.org/10.1007/978-0-387-71327-4_10
Sánchez-Ramos, I., Castañera, P., 2000. Acaricidal activity of natural monoterpenes on Tyrophagus putrescentiae (Schrank), a mite of stored food. J. Stored Prod. Res. 37, 93-101. https://doi.org/10.1016/S0022-474X(00)00012-6
Šimko, P., 2005. Factors affecting elimination of polycyclic aromatic hydrocarbons from smoked meat foods and liquid smoke flavorings. Mol. Nutr. Food Res. 49, 637-647.
Simon, R., de la Calle, B., Palme, S., Meier, D., Anklam, E., 2005. Composition and analysis of liquid smoke flavouring primary products. J. Sep. Sci. 28, 871-882.
Soares, J. M., da Silva, P. F., Puton, B. M. S., Brustolin, A. P., Cansian, R. L., Dallago, R. M., Valduga, E., 2016. Antimicrobial and antioxidant activity of liquid smoke and its potential application to bacon. Innov. Food Sci. Emerg. Technol. 38, 189-197. https://doi.org/10.1016/j.ifset.2016.10.007
Suñen, E., 1998. Minimum inhibitory concentration of smoke wood extracts against spoilage and pathogenic micro-organisms associated with foods. Lett. Appl. Microbiol. 27, 45-48.
Suñen, E., Fernandez-Galian, B., Aristimuño, C., 2001. Antibacterial activity of smoke wood condensates against Aeromonas hydrophila, Yersinia enterocolitica and Listeria monocytogenes at low temperature. Food Microbiol. 18, 387-393. https://doi.org/10.1006/fmic.2001.0411
USDA-FSIS, 9 CFR 319.106, 2021 https://ecfr.io/Title-09/se9.2.319_1106 (Accessed Dec. 15, 2020).
USDA-FSIS 9 CFR 424.21, 2021. 9 CFR 424.21 Retrieved from https://www.law.cornell.edu/cfr/text/9/424.21 (Accessed on Sep. 10, 1921).
Van Loo, E. J., Babu, D., Crandall, P. G., Ricke, S. C., 2012. Screening of commercial and pecan shell-extracted liquid smoke agents as natural antimicrobials against foodborne pathogen. J. Food Prot. 75, 1148-1152. https://doi.org/10.4315/0362-028X.JFP-11-543
Vitt, S. M., Himelbloom, B. H., Crapo, C. A., 2001. Inhibition of Listeria innocua and L. monocytogenes in a laboratory medium and cold-smoked salmon containing liquid smoke. J. food Saf. 21, 111-125.
von Paula Schrank, F., 1781. Enumeratio insectorum Austriae indigenorum. Klett et Franck.
Wendorff, W. L., 1981. Antioxidant and bacteriostatic properties of liquid smoke, in: Proceedings of Smoke Symposium. Red Arrow Products Co. Manitowoc, WI, pp. 73-87.
Wendorff, W. L., Riha, W. E., Muehlenkamp, E., 1993. Growth of molds on cheese treated with heat or liquid smoke. J. Food Prot. 56, 963-966.
Žd'árková, E., 1973. Orientation of Tyrophagus putrescentiae (Schrank) towards olfactory stimuli, in: Proceedings of the 3rd International Congress of Acarology. Springer, pp. 385-389.
Zhang, X., Byron, M. D., Goddard, J., Phillips, T. W., Schilling, M. W., 2018. Use of lard, food grade propylene glycol, and polysaccharides in infused nets to control Tyrophagus putrescentiae (schrank; sarcoptiformes: acaridae) infestation on dry cured hams. Meat Muscle Biol. 2, 36-45. https://doi.org/10.22175/mmb2017.09.0044
Zhang, X., Campbell, Y. L., Phillips, T. W., Abbar, S., Goddard, J., Schilling, M., 2017. Application of food-grade ingredients to nets for dry cured hams to control mite infestations. Meat Muscle Biol. 1, 53-60.
Zhao, Y., Abbar, S., Amoah, B., Phillips, T. W., Schilling, M. W., 2016a. Controlling pests in dry-cured ham: A review. Meat Sci. 111, 183-191.
Zhao, Y., Abbar, S., Phillips, T. W., Schilling, M. W., 2014. Development of food grade coatings to prevent mite infestation on dry cured ham, in: Annual International Research Conference on Methyl Bromide Alternatives and Emission Reduction, Orlando, FL. p. 34.
Zhao, Y., Abbar, S., Phillips, T. W., Williams, J. B., Smith, B. S., Schilling, M. W., 2016b. Developing food-grade coatings for dry-cured hams to protect against ham mite infestation. Meat Sci. 113, 73-79.
Zhao, Y., Teixeira, J. S., Gänzle, M. M., Saldaña, M. D. A., 2018. Development of antimicrobial films based on cassava starch, chitosan and gallic acid using subcritical water technology. J. Supercrit. Fluids 137, 101-110.

We claim:

1. A food-grade coating composition for controlling pest infestation and pest reproduction on or in food, or both, wherein the composition comprises mixtures containing liquid smoke and at least one of xanthan gum, propylene glycol, alginate, and/or carrageenan.

2. The composition of claim 1, comprising about 1% to about 5% by weight or volume of at least one of xanthan gum, propylene glycol, alginate, and/or carrageenan, and about 1% to about 5% by weight or volume of liquid smoke.

3. The composition of claim 1, comprising about 1% by weight or volume of xanthan gum, and about 1% to about 2% by weight or volume of liquid smoke.

4. The composition of claim 1, further comprising a food-grade acceptable carrier for the composition.

5. The composition of claim 4, wherein the carrier is an edible coating or a food container.

6. The composition of claim 5, wherein the food container is a wrap or net.

7. The composition of claim 4, wherein the carrier is a net and the net is a cotton, a cotton blend, a polymer, or a polymer blends.

8. The composition of claim 4, wherein the carrier is a food container, and the food container is a bag, wrap, mesh, net, sock or a combination thereof, that is soaked or infused with the liquid smoke and at least one of xanthan gum.

9. The composition of claim 1, wherein the food is ham, pork, cheese, egg, fermented soy food product, or a combination thereof, and the pests are mites.

10. The composition of claim 1, wherein the composition has the form of a gel, a freeze-dried powder, a film, or a combination thereof.

12. A method for controlling pest infestation and pest reproduction on or in food, or both, the method comprising:
applying a food-grade coating composition on or in the food, or both, for controlling food pests and pest infestations and reproduction on the food;
the composition comprising liquid smoke and at least one of xanthan gum, propylene glycol, alginate, and/or carrageenan.

13. The method of claim 1, wherein the applying step includes infusing at least one food container for containing the food, with the composition applied on or in the food, for storing, processing, aging, curing, or a combination thereof, and wrapping or covering the food with the at least one food container.

14. The method of claim 12, wherein the composition comprises about 1% to about 5% by weight or volume of xanthan gum, and about 1% to about 5% by weight or volume of liquid smoke.

15. The method of claim 12, wherein the composition comprises about 1% by weight or volume of xanthan gum, and about 1% to about 3% by weight or volume of liquid smoke.

16. The method of claim 12, wherein the food is pork, including ham cheese fermented soy food product, or a combination thereof, and the pests are mites.

17. The method of claim 12, wherein the at least one food container is a bag, wrap, mesh, net, or a combination thereof.

18. The method of claim 12, wherein the applying of the composition on or in the food, or both, in an effective amount is by spraying, misting, dipping, machine coating, manual coating, or a combination thereof.

19. A container for controlling pest infestation and pest reproduction on or in food, wherein the container has been treated or infused with the food-grade coating composition of claim 1, wherein the food is either treated or is not treated with an effective amount of the composition, and wherein the container is for storing, processing, aging, curing, or a combination thereof, of the food.

20. The container of claim 19, wherein the container is a bag, wrap, mesh, net, or a combination thereof, that provides contact with the food.

21. The container of claim 19, wherein the container has been treated or infused with the food-grade coating composition of claim 1, and sealed for storage.
